(19) United States
(12) Patent Application Publication
(10) Pub. No.: US 2021/0323404 A1
(43) Pub. Date: Oct. 21, 2021

(54) DISPLAY APPARATUS AND DISPLAY METHOD FOR VEHICLE

(71) Applicants: Hyundai Motor Company, Seoul (KR); Kia Motors Corporation, Seoul (KR)

(72) Inventors: Su Jin Kwon, Suwon (KR); Bum Hee Chung, Seoul (KR); Paul Choo, Seoul (KR)

(21) Appl. No.: 17/002,411

(22) Filed: Aug. 25, 2020

(30) Foreign Application Priority Data
Apr. 21, 2020 (KR) 10-2020-0048169

(51) Int. Cl. B60K 35/00

(52) U.S. Cl. CPC B60K 35/00; B60K 2370/152; B60K 2370/164; B60K 2370/191; B60K 2370/166; B60K 2370/188; B60K 2370/165

(57) ABSTRACT

A display apparatus for a vehicle includes: a controller configured to create a 3D map based on a neon view by selecting essential information among map information; and a display device configured to display the 3D map based on the neon view created by the controller, wherein the controller may apply a gradient effect to a path line or may apply an emphasis effect to a specific predetermined area among the essential information when the 3D map based on the neon view is created.

### CROSS-REFERENCE TO RELATED APPLICATION

This application claims under 35 U.S.C. § 119(a) the benefit of Korean Patent Application No. 10-2020-0048169, filed in the Korean Intellectual Property Office on Apr. 21, 2020, the entire contents of which are incorporated herein by reference.

### BACKGROUND

### (a) Technical Field

The present disclosure relates to a display apparatus for a vehicle and a method thereof, more particularly, to a technique that enables a driver to intuitively recognize important information from map information based on a neon view.

### (b) Description of the Related Art

A vehicle navigation provides map information, as shown in FIG. 1 (RELATED ART), for location search and path guidance.

The location search includes location information for searching for a destination or a waypoint during a stop, and the path guidance includes direction information for reaching a destination while driving.

To this end, the vehicle navigation outputs various information such as a location of a host vehicle (a host vehicle mark), a direction, a cycle (an icon and a name indicating a type), type and color classification by category, buildings and structures, topographical indications such as green/water/altitude, road shapes, and names on the screen.

As described above, when providing map information, all information is simultaneously displayed without distinction of each use, so there is a problem that visibility and usability may be deteriorated due to excess information being displayed in a limited space.

Accordingly, in the related art, a lot of information is redundantly provided, and particularly in a 3D view, a driver may not be able to recognize important information in a timely manner while driving, due to an increase in complexity.

The above information disclosed in this Background section is only for enhancement of understanding of the background of the disclosure, and therefore it may contain information that does not form the prior art that is already known in this country to a person of ordinary skill in the art.

### SUMMARY

An exemplary embodiment of the present disclosure provides a display apparatus for a vehicle and a method thereof, capable of improving visibility of map information and concentration of a driver by minimizing an amount of complicated information such as text or points of interest (POI) of map information, while providing only information necessary for the driver based on a neon view.

In addition, an exemplary embodiment of the present disclosure provides a display apparatus for a vehicle and a method thereof, capable of enabling a driver to intuitively recognize a driving situation by applying a gradient effect for each distance of a path line onto a 3D map based on the neon view or applying a highlight effect to the path line near a destination or a POI.

An exemplary embodiment of the present disclosure provides a display apparatus for a vehicle, including: a controller configured to create a 3D map based on a neon view by selecting essential information among map information; and a display device configured to display the 3D map based on the neon view created by the controller, wherein the controller may apply a gradient effect to a path line or may apply an emphasis effect to a specific predetermined area among the essential information when the 3D map based on the neon view is created.

In an exemplary embodiment, the essential information may include at least one of current location information of a host vehicle, path information, time information, destination information, distance information remaining to a destination, and current time information.

In an exemplary embodiment, the controller may set a color of the path line as a dark color as the path line is closer to a current location of the host vehicle, and may set the color of the path line to gradually fade as it approaches the destination.

In an exemplary embodiment, the controller may set a thickness of the path line to be thicker as the path line is closer to the current location of the host vehicle, and may set the thickness of the path line to be gradually thinned as it approaches the destination.

In an exemplary embodiment, the controller may apply a gradient effect of a color depending on a length of the path line.

In an exemplary embodiment, the controller may divide a total distance from the current location of the host vehicle to the destination into at least one section, and applying a gradient effect of a color depending on a distance for each section.

In an exemplary embodiment, the controller may apply a highlight effect to the path line near a destination.

In an exemplary embodiment, the controller may increase a degree of the highlight effect of the path line as it approaches the destination.

In an exemplary embodiment, the controller may apply a highlight effect to the path line adjacent to a point of interest on the 3D map.

In an exemplary embodiment, the controller may apply colors and perform transparent processing of overlapped structured displayed on the 3D map based on the neon view such that each surface of the structures is distinguished.

An exemplary embodiment of the present disclosure provides a display method for a vehicle, including: selecting essential information among map information; creating a 3D map based on a neon view to display the essential information thereon, and applying a gradient effect to a color of a path line or applying an emphasis effect to a specific predetermined area among the essential information when the 3D map based on the neon view is created; displaying the 3D map.

In an exemplary embodiment, the applying of the gradient effect may include setting the color of the path line as a dark color as the path line is closer to a current location of the host vehicle, and setting the color of the path line to gradually fade as it approaches the destination.

In an exemplary embodiment, the applying of the gradient effect may include setting a thickness of the path line to be thicker as the path line is closer to the current location of the host vehicle, and setting the thickness of the path line to be gradually thinned as it approaches the destination.

In an exemplary embodiment, the applying of the gradient effect may include applying the gradient effect of the color depending on a length of the path line.

In an exemplary embodiment, the applying of the gradient effect may include dividing a total distance from the current location of the host vehicle to the destination into at least one section, and applying a gradient effect of a color depending on a distance for each section.

In an exemplary embodiment, the applying of the gradient effect may include applying a highlight effect to the path line near a destination.

In an exemplary embodiment, the applying of the gradient effect may include increasing a degree of the highlight effect of the path line as it approaches the destination.

In an exemplary embodiment, the applying of the gradient effect may include applying a highlight effect to the path line adjacent to a point of interest on the 3D map.

In an exemplary embodiment, the applying of the emphasis effect may include applying colors and perform transparent processing of overlapped structured displayed on the 3D map based on the neon view such that each surface of the structures is distinguished.

The above-described technique may express information to a driver simply and intuitively and display it in a timely manner by minimizing the amount of complex information such as text or POI of vehicle information and guiding only the information necessary for the driver based on a neon view, so as to increase visibility of vehicle information and concentration of the driver.

The above-described technique may also enable a driver to intuitively recognize a driving situation by applying a gradient effect for each distance of a path line onto the 3D map based on the neon view or applying a highlight effect to the path line near a destination or a POI.

### BRIEF DESCRIPTION OF THE DRAWINGS

FIG. 1 (RELATED ART) illustrates an example of a screen displaying map information in a vehicle.

FIG. 2 illustrates a block diagram showing a configuration of a display apparatus for a vehicle according to an exemplary embodiment of the present disclosure.

FIG. 3 illustrates an exemplary screen of map information based on a neon view white according to an exemplary embodiment of the present disclosure.

FIG. 4 illustrates an example of a screen of map information based on a neon view black according to an exemplary embodiment of the present disclosure.

FIG. 5 illustrates an example of a screen for setting a surface color and transparency in map information based on a neon view white according to an exemplary embodiment of the present disclosure.

FIG. 6 illustrates an example of a screen for setting a surface color and transparency in map information based on a neon view black according to an exemplary embodiment of the present disclosure.

FIG. 7 illustrates an example of a screen for displaying a gradient effect of a path line in map information based on a neon view white according to an exemplary embodiment of the present disclosure.

FIG. 8 illustrates an example of a screen for displaying a gradient effect of a path line in map information based on a neon view black according to an exemplary embodiment of the present disclosure.

FIG. 9 illustrates a view for describing a gradient effect of a path line in map information based on a neon view according to an exemplary embodiment of the present disclosure.

FIG. 10 illustrates an example of a screen for highlights near a destination in map information based on a neon view white according to an exemplary embodiment of the present disclosure.

FIG. 11 illustrates an example of a screen for highlights near a destination in map information based on a neon view black according to an exemplary embodiment of the present disclosure.

FIG. 12 illustrates a flowchart for describing a method for displaying vehicle information based on a neon view according to an exemplary embodiment of the present disclosure.

### DETAILED DESCRIPTION OF THE EMBODIMENTS

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Hereinafter, some exemplary embodiments of the present disclosure will be described in detail with reference to exemplary drawings. It should be noted that in adding reference numerals to constituent elements of each drawing, the same constituent elements have the same reference numerals as possible even though they are indicated on different drawings. In addition, in describing exemplary embodiments of the present disclosure, when it is determined that detailed descriptions of related well-known configurations or functions interfere with understanding of the exemplary embodiments of the present disclosure, the detailed descriptions thereof will be omitted.

In describing constituent elements according to an exemplary embodiment of the present disclosure, terms such as first, second, A, B, (a), and (b) may be used. These terms are only for distinguishing the constituent elements from other constituent elements, and the nature, sequences, or orders of the constituent elements are not limited by the terms. In addition, all terms used herein including technical scientific terms have the same meanings as those which are generally understood by those skilled in the technical field to which the present disclosure pertains (those skilled in the art) unless they are differently defined. Terms defined in a generally used dictionary shall be construed to have meanings matching those in the context of a related art, and shall not be construed to have idealized or excessively formal meanings unless they are clearly defined in the present specification.

The present disclosure discloses a technique capable of minimizing an amount of complex information such as text or points of interest (POI) by deleting unnecessary information and displaying only necessary information based on a neon view when the information is provided through a display apparatus for a vehicle, to maximize visibility. In addition, the present disclosure enables a driver to intuitively recognize important information from map information based on a neon view by applying a gradient effect for each distance of a path line on a 3D map based on a neon view or applying a highlight effect to the path line near important information (a destination, a POI, etc.).

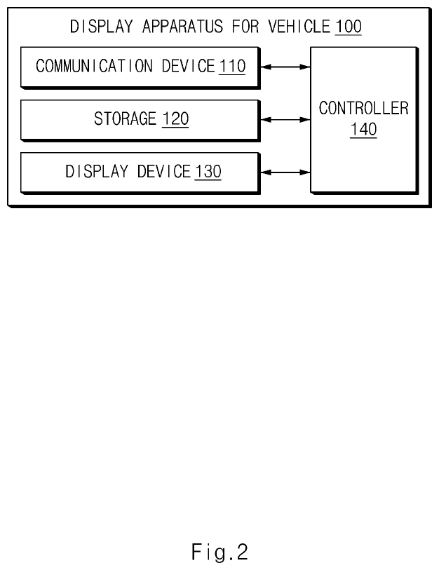

Hereinafter, exemplary embodiments of the present disclosure will be described in detail with reference to FIGS. 2 to 12.

FIG. 2 illustrates a block diagram showing a configuration of a display apparatus for a vehicle according to an exemplary embodiment of the present disclosure.

Referring to FIG. 2, according to an exemplary embodiment of the present disclosure, the display apparatus 100 may be implemented inside the vehicle. In this case, the display apparatus 100 may be integrally formed with internal control units of the vehicle, or may be implemented as a separate device to be connected to control units of the vehicle by a separate connection arrangement.

The display apparatus 100 may create and display a view of a map based on a neon view by deleting unnecessary information (text, POI, etc.) from map information and selecting only certain information that is deemed “essential” to a driver while driving.

In this case, the neon view may include neon white and neon black, where neon white is a method of displaying a map in shades of buildings and terrain on a light background, and neon black is a method of displaying buildings and terrain on a dark background by using outlines.

To this end, the display apparatus 100 may include a communication device 110, a storage 120, a display device 130, and a controller 140.

The communication device 110, which is a hardware device implemented with various electronic circuits to transmit and receive signals through a wireless or wired connection, may perform V2I communication by using an in-vehicle network communication technique or a wireless Internet access or short range communication technique with servers, infrastructure, and other vehicles outside the vehicle in the present disclosure. Herein, in-vehicle communication may be performed through controller area network (CAN) communication, local interconnect network (LIN) communication, or flex-ray communication as the in-vehicle network communication technique. In addition, the wireless communication technique may include wireless LAN (WLAN), wireless broadband (Wibro), Wi-Fi, world Interoperability for microwave access (Wimax), etc. In addition, short-range communication technique may include bluetooth, ZigBee, ultra wideband (UWB), radio frequency identification (RFID), infrared data association (IrDA), and the like.

As an example, the communication device 110 may transmit or receive information related to surrounding conditions of a driving road, e.g., traffic accidents, road construction, traffic congestion, and the like with respect to surrounding vehicles or surrounding infrastructure. Subsequently, the controller 140 may reflect information related to the surrounding conditions of the driving road, received from the communication device 110 on a 3D map based on a neon view.

As an example, the storage 120 may store map information, and the like for providing a path. In addition, the storage 120 may store information such as a driving situation and a traffic situation received through V2X communication. The storage 120 may also store instructions and/or algorithms for generating map information based on the neon view by the controller 140.

The storage 120 may include a storage medium of at least one type among memories of types such as a flash memory, a hard disk, a micro, a card (e.g., an secure digital (SD) card or an extreme digital (XD) card), a random access memory (RAM), a static RAM (SRAM), a read-only memory (ROM), a programmable ROM (PROM), an electrically erasable PROM (EEPROM), a magnetic memory (MRAM), a magnetic disk, and an optical disk.

The display device 130 may include a display, and optionally may include a voice output mechanism such as a speaker.

As an example, the display device 130 may display a driving situation, map information, path information, and the like, and may display map information based on the neon view.

In this case, when a touch sensor formed of a touch film, a touch sheet, or a touch pad is provided on the display, the display may operate as a touch screen, and may be implemented in a form in which an input device and an output device are integrated.

In this case, the display may include at least one of a liquid crystal display (LCD), a thin film transistor liquid crystal display (TFT LCD), an organic light emitting diode display (OLED display), a flexible display, a field emission display (FED), and a 3D display.

The display device 130 may be implemented as a head-up display (HUD), a cluster, an audio video navigation (AVN), or a human machine interface (HMI). In addition, the display device 130 may include at least one of a liquid crystal display (LCD), a thin film transistor liquid crystal display (TFT LCD or thin film transistor-LCD), a light emitting diode (LED) display, an organic light emitting diode (OLED or organic LED) display, an active OLED (AMOLED or active matrix OLED) display, a flexible display, a bended display, and a 3D display. Some of these displays may be implemented as transparent displays formed of a transparent or translucent type such that the outside can be viewed. In addition, the display device 130 may be provided as a touch screen including a touch panel, and may be used as an input device as well as an output device.

In this case, the display device 130 may include an input device for receiving a control instruction from a user, and the input device may include a key button, and may also include a mouse, a joystick, a jog shuttle, a stylus pen, or the like. In addition, the input device 250 may include a soft key implemented on the display.

The processor 140 may be electrically connected to the communication device 110, the storage 120, the display device 130, and the like, may electrically control each component, and may be an electrical circuit that executes software commands, thereby performing various data processing and calculations described below. The controller 140 may be, e.g., an electronic control unit (ECU), a micro controller unit (MCU), or other subcontrollers mounted in the vehicle.

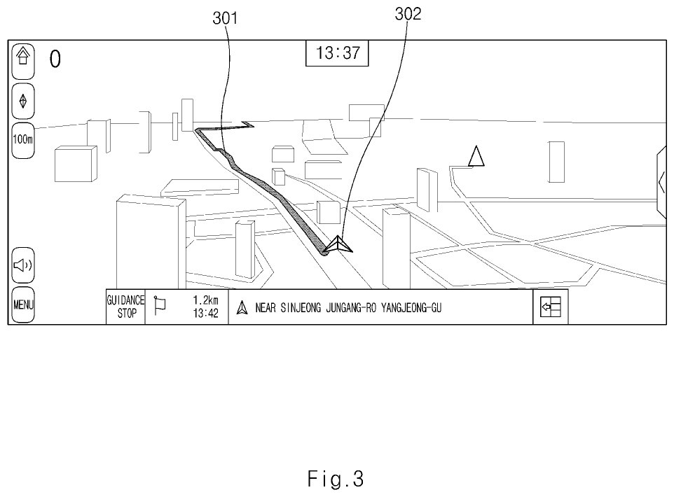

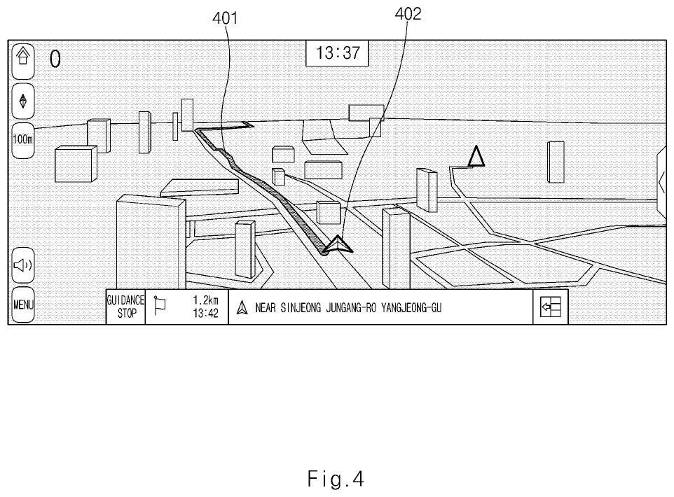

The controller 140 selects essential information from the map information and creates a 3D map based on the neon view. In this case, when the 3D map based on the neon view is created, the controller 140 may display a structure on a background screen of the map information by using a shadow as illustrated in FIG. 3, or may display the structure on a dark background screen by using outlines of the structure as illustrated in FIG. 4. FIG. 3 illustrates an exemplary screen of map information based on a neon view white according to an exemplary embodiment of the present disclosure, and FIG. 4 illustrates an example of a screen of map information based on a neon view black according to an exemplary embodiment of the present disclosure. In FIG. 3 and FIG. 4, the surrounding information is minimized and displayed such that a location of a host vehicle 302 and 402 and a path line 301 and 401, which is essential information on the surrounding background, are visible at a glance. In this case, the essential information may include at least one of current location information of a host vehicle, path information, time information, destination information, distance information remaining to the destination, and current time information.

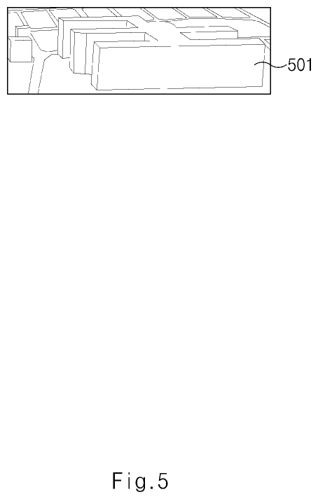

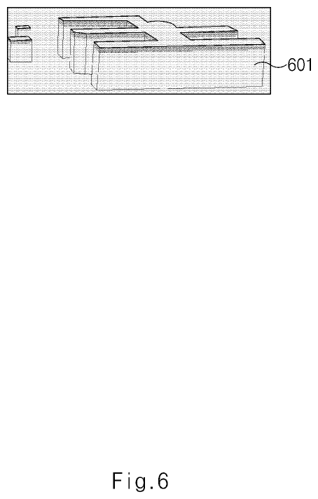

The controller 140 may apply colors and perform transparent processing of overlapped structures displayed on the 3D map based on the neon view such that each surface of the structures may be distinguished. FIG. 5 illustrates an example of a screen for setting a surface color and transparency in map information based on a neon view white according to an exemplary embodiment of the present disclosure, and FIG. 6 illustrates an example of a screen for setting a surface color and transparency in map information based on a neon view black according to an exemplary embodiment of the present disclosure. Due to a characteristic of the 3D map, when a display level that is suitable for driving (e.g., 100 to 250 m) is maintained, it is difficult to recognize an overall structure of buildings, a shape of an obscured portion, or a shape of a road due to occlusion of most of the buildings. As illustrated in FIG. 5 and FIG. 6, the buildings are transparently processed, and a shade or color may be differently set to distinguish upper surfaces and wall surfaces of the buildings in order to eliminate obstruction between buildings 501 and 601.

When the map based on the neon view is created, the controller 140 may apply the gradient effect to the color of the path line among essential information.

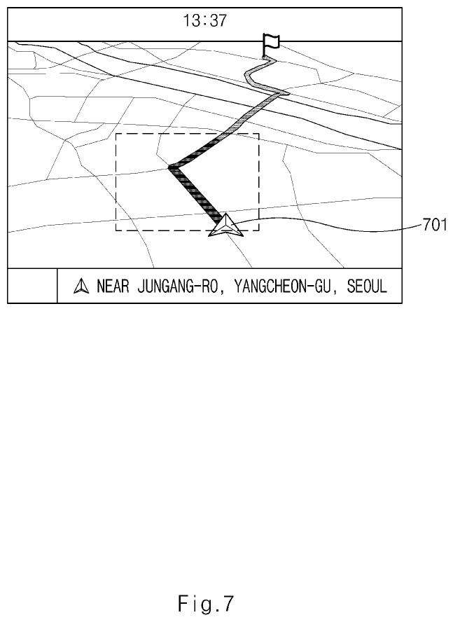

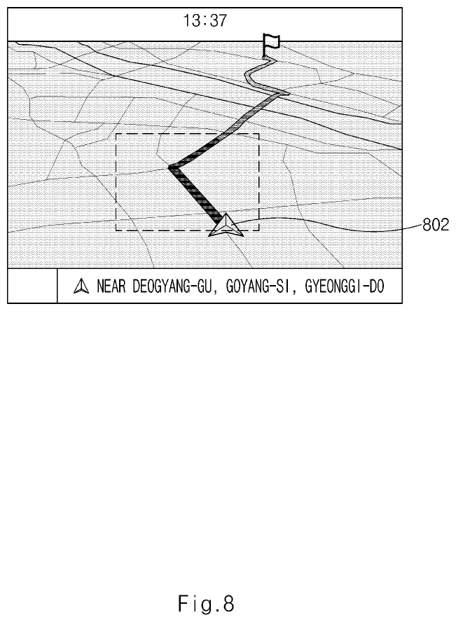

The controller 140 may set a color of the path line as a dark color as the path line is closer to a current location of the host vehicle, and may set the color of the path line to gradually fade as it approaches a destination. FIG. 7 illustrates an example of a screen for displaying a gradient effect of a path line in map information based on a neon view white according to an exemplary embodiment of the present disclosure, and FIG. 8 illustrates an example of a screen for displaying a gradient effect of a path line in map information based on a neon view black according to an exemplary embodiment of the present disclosure. It can be seen that the color of the path line near a current location 701 and 801 of the host vehicle of FIG. 7 and FIG. 8 is darker than that of the path line near the destination, and the color is blurred as it gets closer to the destination.

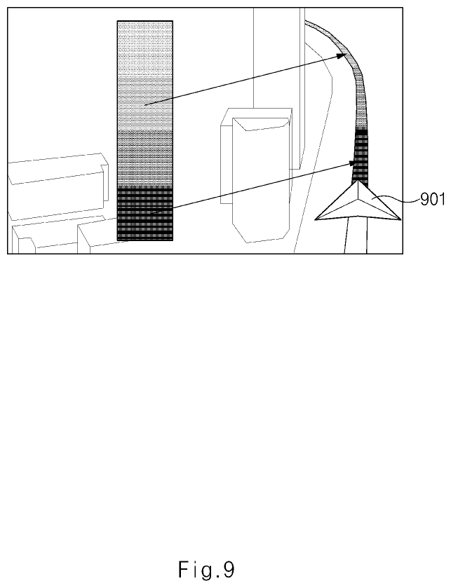

The controller 140 may set a thickness of the path line to be thicker as the path line is closer to the current location of the host vehicle, and may set the thickness of the path line to be gradually thinned as it approaches the destination. It can be seen that the thickness of the path line near the current location 701 and 801 of the host vehicle of FIG. 7 and FIG. 8 is thicker than that of the path line near the destination, and the color is thinner as it gets closer to the destination. FIG. 9 illustrates a view for describing a gradient effect of a path line in map information based on a neon view according to an exemplary embodiment of the present disclosure. For a mapping of left color coordinates and the path line in FIG. 9, it can be seen that a color gradient depending on the color coordinates is darker as it gets closer to a current location 901 of the host vehicle and is thinner as it gets more distant from the current location 901.

The controller 140 may apply a gradient effect of a color depending on a length of the path line. That is, the controller 140 may divide a total distance from the current location of the host vehicle to the destination into at least one section, and may apply a gradient effect of a color depending on a distance for each section.

TABLE 1

| Color coordinate gradient range | Mileage |
|---|---|
| 1-5 | 10,000 m |
| 6-7 | 5000 m |
| 8-9 | 4000 m |
| 10 | 3000 m |
| 11-12 | 2000 m |
| 13-14 | 1500 m |
| 15 | 1000 m |
| 16-19 | 500 m |

Table 1 shows a driving distance for each gradient range of the color coordinates. For example, when the path line is drawn in an order of color coordinates 1, 8, 11, and 15, it may be estimated that a total driving distance is 1.7 km by summing all 10,000 m, 4000 m, 2000 m, and 1000 m.

That is, a driver may be allowed to estimate the total distance by viewing a change in the color of the path line without checking an entire path by gradiently expressing the color to be appropriate for a value depending on each distance based on the total distance from the current location of the host vehicle to the destination.

The path line may be displayed by applying various methods capable of gradually displaying it without being limited to gradiently expressing a color or a thickness of the path line.

The controller 140 may apply an emphasis effect to a specific predetermined area (e.g., a destination, a POI, an accident point, a gas station, etc.) among essential information. That is, the controller 140 may apply a highlight effect to the path line near the destination. In this case, the controller 140 may increase a degree of the highlight effect of the path line as it approaches the destination. For example, when a waypoint is selected, the destination may be allowed to be checked at a glance by gradiently expressing a basic color from the current location of the host vehicle to the waypoint, and applying a highlight to the path line from the waypoint to the destination, but applying a highlight having more intensity to the path line near to the destination. In addition, the controller 140 may allow the driver to easily recognize important information while driving by applying the highlight effect to the POI or the path line adjacent to an area selected by the driver as important information on the 3D map.

The path line may be displayed by applying various methods for emphasizing important information, not limited to the expression to be emphasized by applying the highlight effect to the path line described above.

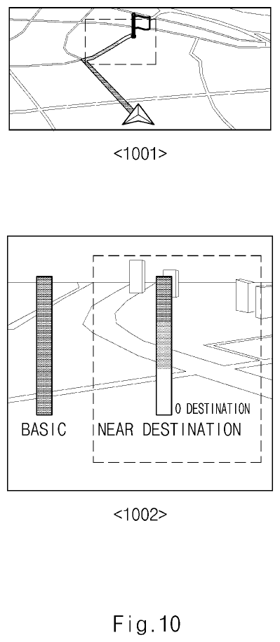

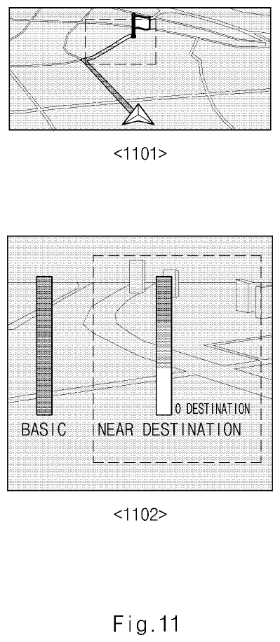

FIG. 10 illustrates an example of a screen for highlights near a destination in map information based on a neon view white according to an exemplary embodiment of the present disclosure, and FIG. 11 illustrates an example of a screen for highlights near a destination in map information based on a neon view black according to an exemplary embodiment of the present disclosure.

A screen 1001 in FIG. 10 and a screen 1101 in FIG. 11 show a state in which a highlight effect is applied by applying high brightness and high saturation colors of the path line near the destination. The screen 1002 in FIG. 10 and the screen 1102 in FIG. 11 show a comparison of a basic path line indicating the path line around the current location of the host vehicle and a highlighted path line near the destination.

TABLE 2

| Highlight level | Distance |
|---|---|
| 1-15 | 1000 m |
| 16-19 | 300 m |

Table 2 shows a distance for each level of a highlight effect. For example, when a highlight level near the destination is set to 7, the corresponding distance may be estimated to be 1000 m. In addition, for example, a path line within 300 m based on a distance from a destination may apply the highlight effect with a highlight level of 16 to 19. Accordingly, a driver can intuitively know a destination proximity level of the host vehicle while driving by looking at the location of the host vehicle and the path line to which the highlight effect has been applied.

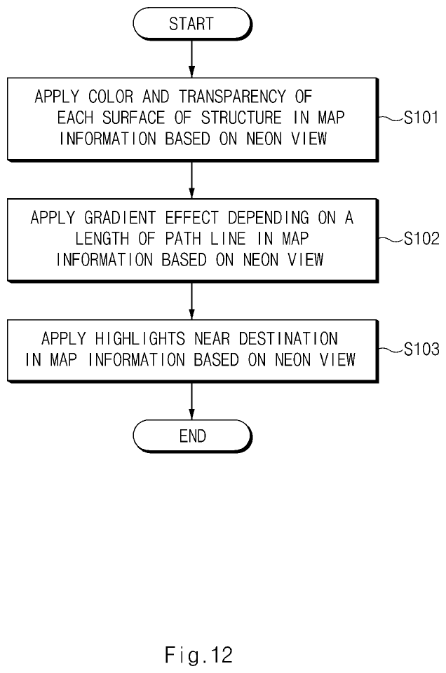

Hereinafter, a method for displaying vehicle information based on a neon view according to an exemplary embodiment of the present disclosure will be described in detail with reference to FIG. 12. FIG. 12 illustrates a flowchart for describing a method for displaying vehicle information based on a neon view according to an exemplary embodiment of the present disclosure.

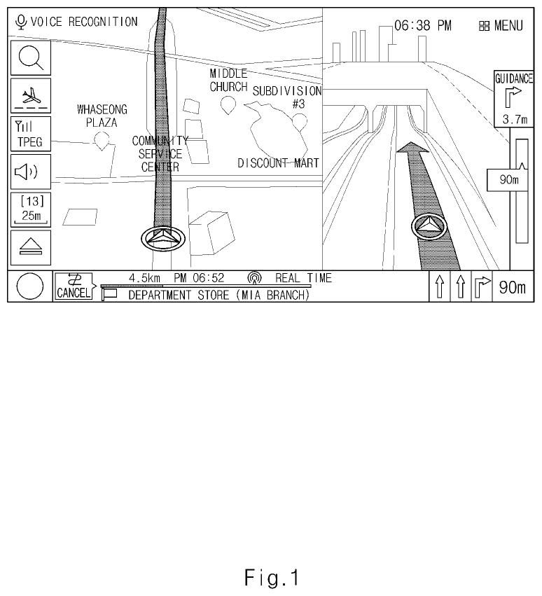

Hereinafter, it is assumed that the display apparatus 100 of the vehicle of FIG. 1 performs a process of FIG. 12. In addition, in the description of FIG. 12, operations described as being performed by a device may be understood as being controlled by the controller 140 of the display apparatus 100.

Referring to FIG. 12, the display apparatus 100 may differently apply a color and transparency of each surface of the structure in the map information based on the neon view (S101). Due to a characteristic of the 3D map, when a display level that is suitable for driving is maintained, it may be difficult to recognize an overall structure of buildings, a shape of an obscured portion, or a shape of a road due to occlusion of most of the buildings. Accordingly, the display apparatus 100 may apply transparency to eliminate the occlusion phenomenon between the buildings. In FIG. 5 and FIG. 6, the color and transparency of each surface of the buildings may be differently applied in the map information based on the neon view.

The display apparatus 100 applies the gradient effect depending on a length of the path line in the map information based on the neon view (S102). As in FIG. 7, FIG. 8, and FIG. 9, the gradient effect depending on the length of the path line may be applied to the map information based on the neon view. The path line may be displayed in a dark color as it is closer to the current location of the host vehicle, and may be displayed to be lighter as it approaches the destination. In addition, since the distance can be estimated depending on intensity of the color of the path line, it is possible to intuitively determine a total distance from the host vehicle location to the destination by the change of the color of the path line.

The display apparatus 100 applies highlights near the destination in the map information based on the neon view (S103). That is, the display apparatus 100 may provide a screen for the driver to intuitively know a proximity level of the host vehicle to the destination through a separate texture mapping for a vicinity of the destination.

As shown in a screen 1001 in FIG. 10 and a screen 1101 in FIG. 11, whether a location of the host vehicle is near the destination may be seen by highlighting the vicinity of the destination, and as shown in a screen 1002 in FIG. 10 and a screen 1102 in FIG. 11, the path line around the current location of the host vehicle may be displayed in the basic color, and a high-brightness and high-saturation color may be displayed in the vicinity of the destination such that the highlight effect can be displayed. In addition, the display apparatus 100 may display a POI that is adjacent to a driving path such as a waypoint, an accident point, or a gas station as well as the destination.

As described above, according to the present disclosure, it is possible to increase visibility by minimizing complex information such as text or POI when providing map information through the display apparatus 100 and by selecting only information that is essential to a driver (e.g., location information and path information) and displaying it based on the neon view.

In addition, the present disclosure may apply a variety of gradient effects, highlight effects, and the like to textures related to a destination, a POI, and the like, to intuitively recognize necessary information, and to increase aesthetic completeness.

The above description is merely illustrative of the technical idea of the present disclosure, and those skilled in the art to which the present disclosure pertains may make various modifications and variations without departing from the essential characteristics of the present disclosure.

Therefore, the exemplary embodiments disclosed in the present disclosure are not intended to limit the technical ideas of the present disclosure, but to explain them, and the scope of the technical ideas of the present disclosure is not limited by these exemplary embodiments. The protection range of the present disclosure should be interpreted by the claims below, and all technical ideas within the equivalent range should be interpreted as being included in the scope of the present disclosure.

What is claimed is:

1. A display apparatus for a vehicle, comprising:
a controller configured to create a 3D map based on a neon view by selecting essential information among map information; and
a display device configured to display the 3D map based on the neon view created by the controller,
wherein the controller applies a gradient effect to a path line or applies an emphasis effect to a specific predetermined area among the essential information when the 3D map based on the neon view is created.

2. The display apparatus of claim 1, wherein the essential information includes at least one of current location information of a host vehicle, path information, time information, destination information, distance information remaining to a destination, and current time information.

3. The display apparatus of claim 1, wherein the controller sets a color of the path line as a dark color as the path line is closer to a current location of a host vehicle, and sets the color of the path line to gradually fade as it approaches a destination.

4. The display apparatus of claim 1, wherein the controller sets a thickness of the path line to be thicker as the path line is closer to a current location of a host vehicle, and sets the thickness of the path line to be gradually thinned as it approaches a destination.

5. The display apparatus of claim 1, wherein the controller applies the gradient effect of a color depending on a length of the path line.

6. The display apparatus of claim 1, wherein the controller divides a total distance from a current location of a host vehicle to a destination into at least one section, and applies the gradient effect of a color depending on a distance for each section.

7. The display apparatus of claim 1, wherein the controller applies a highlight effect to the path line near a destination.

8. The display apparatus of claim 7, wherein the controller increases a degree of the highlight effect of the path line as it approaches the destination.

9. The display apparatus of claim 1, wherein the controller applies a highlight effect to the path line adjacent to a point of interest on the 3D map.

10. The display apparatus of claim 1, wherein the controller applies colors and perform transparent processing of overlapped structures displayed on the 3D map based on the neon view such that each surface of the structures is distinguished.

11. A display method for a vehicle, comprising:
selecting, by a controller, essential information among map information;
creating, by the controller, a 3D map based on a neon view to display the essential information thereon, and applying a gradient effect to a color of a path line or applying an emphasis effect to a specific predetermined area among the essential information when the 3D map based on the neon view is created;
displaying, by a display device, the 3D map.

12. The display method of claim 11, wherein applying the gradient effect includes setting a color of the path line as a dark color as the path line is closer to a current location of a host vehicle, and setting the color of the path line to gradually fade as it approaches a destination.

13. The display method of claim 11, wherein applying the gradient effect includes setting a thickness of the path line to be thicker as the path line is closer to a current location of a host vehicle, and setting the thickness of the path line to be gradually thinned as it approaches a destination.

14. The display method of claim 11, wherein applying the gradient effect includes applying the gradient effect of the color depending on a length of the path line.

15. The display method of claim 11, wherein applying the gradient effect includes dividing a total distance from a current location of a host vehicle applying a destination into at least one section, and applying the gradient effect of the color depending on a distance for each section.

16. The display method of claim 11, wherein applying the gradient effect includes applying a highlight effect to the path line near a destination.

17. The display method of claim 16, wherein applying the gradient effect includes increasing a degree of the highlight effect of the path line as it approaches the destination.

18. The display method of claim 17, wherein applying the gradient effect includes applying a highlight effect to the path line adjacent to a point of interest on the 3D map.

19. The display method of claim 11, wherein applying the emphasis effect includes applies colors and performing transparent processing of overlapped structured displayed on the 3D map based on the neon view such that each surface of the structures is distinguished.
